(19) United States
(12) Patent Application Publication
(10) Pub. No.: US 2003/0230539 A1
(43) Pub. Date: Dec. 18, 2003

(54) Diesel engine fuel filtration system for use with waste oil

(76) Inventor: Michael Shetley, Okeechobee, FL (US)

Correspondence Address: Michael A. Slavin, McHale & Slavin, P.A., Suite 402, 4440 PGA Boulevard, Palm Beach Gardens, FL, 33410, US

(21) Appl. No.: 10/449,952

(22) Filed: May 29, 2003

Related U.S. Application Data
(60) Provisional application No. 60/386,029, filed on Jun. 4, 2002.

(51) Int. Cl. B01D 37/00

(52) U.S. Cl. 210/767; 210/435; 210/443; 210/444

(57) ABSTRACT

A diesel engine filtration system and composition for use with waste oil. The filtration system adapts a high flow fiberglass fuel filter to a conventional paper element fuel filter system to accommodate the higher viscosity of waste oil and allow passage of water. A composition is added to the waste oil to maintain water in suspension and prevent separation of the fluids. The waste oil providing conventional diesel operating engines to operate on the higher quality waste oil which provides a higher BTU for cooler engine operation.

### REFERENCE TO RELATED APPLICATIONS

This application is a continuation of a Provisional application S. No. 60/386,029, filed Jun. 4, 2002, the contents of which are herein incorporated by reference in their entirety.

### FIELD OF THE INVENTION

The present invention relates generally to field of diesel engines and more particularly to a filtration system which permits the use of unblended waste oil as an alternative fuel in diesel engines by treating of waste oil to prevent fluid separation.

### BACKGROUND INFORMATION

The instant inventor was previously granted U.S. Pat. No. 5,336,396 for a Waste Oil Management System, the contents of which are incorporated herein by reference. The '396 patent teaches the use of a blended fuel system that includes a filtration system to restrict the passage of particulates and sediment commonly found in waste oil.

Conventional fuel filtration systems used for diesel fuel powered engines consist of a micro-porous filter membrane placed between the fuel storage tank and the fuel injection system for removing of various impurities. Diesel engines are especially sensitive to fuel impurities which are the prime source of injection system problems. During transportation, transfer, and even storage of fuel, impurities can be introduced into the fuel. For instance, condensation forming on the interior walls of a partially filled fuel storage tank can combine with other contaminants of diesel fuel and encourage microbiological growth which can generate a fuel restricting sludge that will affect most diesel fuel injection systems. Waste oils typically have sediment, sulfur, heavy metals such as iron, chromium, lead, copper, tin, aluminum, nickel, silver, manganese, as well as water making the oil suitable only for disposal. These oil contaminants can cause wear, gumming, corrosion, and rust in a fuel system. Combined with water, compounds such as sulfur makes the fuel acidic, which enhances corrosion in fuel injection systems as well as in the engine itself. Further, contaminated water corrodes and erodes injection nozzles disrupting injector spray patterns which leads to improper fuel atomization. Tank sediment and line contamination all lead to fuel degradation.

In systems where water and fuel pass through high shear pumps, fuel/water interfacial tension is relatively low and fine emulsions may predominate. In systems where water enters before or after low shear pumps, or where there is a prolonged settling time in high interfacial tension fuel, larger water droplets may predominate. In some systems, both fine emulsions and large droplets may be present simultaneously. Thus, most diesel fuel is filtered for the removal of water and most waste oil contains a high amount of water.

The '396 Patent includes a disclosure for blending of fuels for use in a diesel fuel injection system. Typically the operating of larger percentages of waste oil invites disaster but the patented system taught that when waste fuel is blended with diesel fuel, the blended fuel provided a higher grade of fuel providing more BTU's per pound resulting in better engine performance. However, the '396 system required retrofitting of a fuel system to maintain proper line runs, shear pumps, and blending percentages.

Therefore, what is lacking in the art is a means for modifying a conventional diesel engine filtration system to operate on lubricating oils, hydraulic oils and the like waste oils. What has been discovered is that diesel engines can be modified to operate on unblended waste fuel oil with minimal retrofit once the waste oil is stabilized and properly filtered.

### SUMMARY OF THE INVENTION

The present invention satisfies the aforementioned needs by teaching a means for using waste oil in conventional diesel engines by adapting an existing filtration system for waste oil operation by modification of the existing fuel filtration system and stabilizing the waste oil by use of a proprietary additive.

A filter adapter is provided to convert an existing fuel filter to receive a fiberglass filter having an oversized inlet and outlet to handle higher fluid viscosities. A fiberglass filter is provided for the reduction/removal of heavy metals and the like contaminants, but will not shear fluids to cause separation. Water need not be removed when a waste oil additive is added to maintain water in suspension. The fiberglass filter allows water to pass and, when water is in a purified state, the water is used to clean the carbon from engine cylinders. The water separator located on most fuel separators need not be disabled, however, water separation would occur only when the fuel is left to stagnate for a long period of time wherein condensation can form on the side walls of the fuel cell.

Accordingly, an objective of the present invention is to provide an fuel filter adapter that will allow the use of a conventional filtration system without the need for any retrofitting.

Still another objective to provide an onboard engine fuel treatment system to allow the use of a stabilized waste fuel without additional pretreatment.

Still another objective of the present invention is to provide a fiberglass filter that will not clog from emulsified fluids and will allows blended fuels to remain in solution, while removing metals namely, iron, chromium, lead, copper, tin, aluminum, nickel, silver, manganese, from the waste oil.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is an exploded side view of a prior art fuel oil filter;

FIG. 2 is an exploded side view-of a modified fuel oil filter according to the instant invention;

FIG. 3 is a top plane view of the fuel oil adapter;

FIG. 4 is a side plane view of the fuel oil adapter of FIG. 3; and

FIG. 5 is a bottom plane view of the fuel oil adapter of FIG. 3.

### DETAILED DESCRIPTION

Although the invention will be described in terms of a specific embodiment, it will be readily apparent to those skilled in this art that various modifications, rearrangements and substitutions can be made without departing from the spirit of the invention. The scope of the invention is defined by the claims appended hereto.

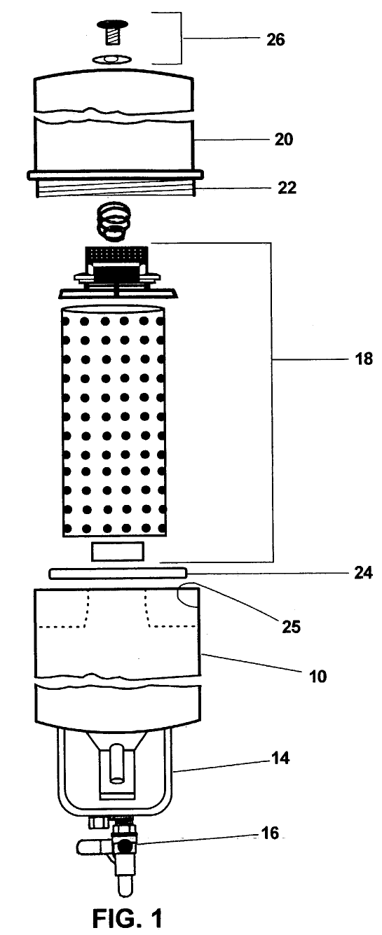

Now referring to FIG. 1, shown is a prior art fuel filter manufactured by the WEBB corporation. The filter has a main support body 10 with a bottom dome 14 allowing visual sight of water that has been separated. Drain valve 16 is used for draining water from the bottom dome. The filter 18 is typically a paper filter used to remove various contaminants from the fuel oil. The paper filter would remove or otherwise clog if subjected to a higher viscosity waste oil. The filter is secured to the body 10 by a dome top 20 which sandwiches the filter 18 between the top and the body when the top is threaded 22 to the internal threads 25 located on the body. Gasket 24 seals the top dome 20 to the body 10. Vent assembly 26 permits the release of trapped air from the filter.

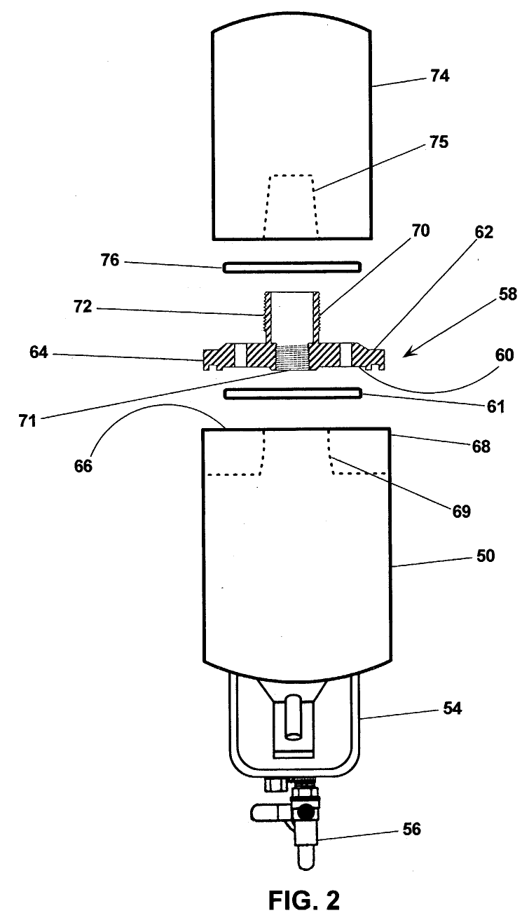

Now referring to FIG. 2, shown is the fuel filter assembly of FIG. 1 modified pursuant to the instant invention for use with waste oil. The filter assembly retains the support body 50 with a bottom dome 54, and drain valve 56. The bottom dome 54 providing the housing for a water separator that will now have little effect, but need not be removed. A mounting plate 58 is employed to receive a fiberglass filter 74. The mounting plate 58 has a first side surface 60 and a second side surface 62 bounded by an outer perimeter 64 which is sized to fit within the body 50, and in particular, within the cavity 66 formed by a lip 68 which extends upwardly from the threaded nipple 69 located within the cavity. Sealing gasket 61 forms a seal between the mounting plate 58 and the body 50. The mounting plate 58 has a centrally located coupling pipe 70 with an interior thread 71 formed along the first side surface 60 for engaging of the threaded nipple 69. The outer surface 72 of the coupling pipe 70 contains threads 72 for engaging the filter 74. The filter 74 having a threaded inlet 75 allowing the filter 74 to engage the upper surface 62 of the mounting plate 58 with gasket 76 providing a seal.

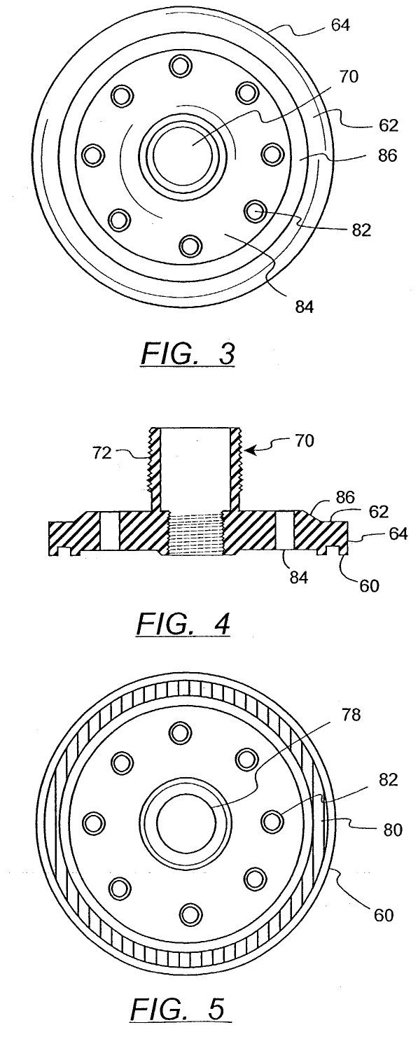

Referring now to FIGS. 3-5 the mounting plate 58 is further defined as a circular plate constructed from aluminum having a first side surface 60 and a second side surface 62 bounded by the outer perimeter 64. The mounting plate is sized to fit within the conventional body support 50. The coupling pipe 70 has an interior threaded 78 opening at least one inch in diameter which meets, and is typical of, a conventional filter holder. The first side surface 60 includes a groove 80 for receipt of a gasket to form a seal between the mounting plate and the body 50. Between the groove 80 and the coupling pipe is a plurality of through holes 82 to provide unrestricted fuel flow between the upper and lower surfaces. The upper surface 62 includes a raised surface 84 obtained by angle edge 86. The raised surface 84 juxtapositioning the through holes 82 in relation to filter housing intake openings. The outer surface of the coupling pipe 70 is an oversize 1 ½ inch external thread to receive the specialty filter 74 for use with high viscosity oils.

The filter 74 contains a proprietary fiberglass media although fiberglass filters, such as those manufactured by PALL Ultripor III or Eaton having a filtration ratio βx of 200, can be used if equipped with the oversize inlet. It should be noted that, contrary to conventional fuel system filtration teachings, the fiberglass filter provides selective non-fluid contaminant reduction of sediment, heavy metals, and particulates. The filter need not remove water as long as the water is held in suspension.

Proper cartridge attachment allows the waste oil to surround the fiberglass element in a manner similar to a filter used in the food processing industry. The waste oil passes through the filter into the perforated central support pipe. Waste oil that passes into the perforated support pipe is directed outwardly from the oversized outlet. The centrifugal separator found in water separators need not be disabled and operate to remove large formations of water found when a fuel tank is not circulated for long periods of time. Once the engine is running, circulation of the fuel allows the water to be held in suspension.

When the filtration system is adapted for use with a conventional diesel engine system without a blended fuel source, as previously taught by the invention, a fuel enhancer is required for maintaining of the oil and water in solution. A solution of petroleum distillate is admixed with a judicially acceptable amount of naphthalene and methylcyclopentadienyl manganese tricarbonyl together with mixed-t-butylphenols and polyisobutenyl succinimide amide capable of maintaining water in suspension and preventing the separation of blended waste oils. The composition further operates as a detergent to prevent sludge build up in fuel lines and pumps. The water that is maintained in suspension operates to remove excess carbon from the cylinder walls due to the higher heat output created by the water. It should be noted that the water must be filtered to remove containments for effective operation as a cylinder wall cleaner.

It is to be understood that while I have illustrated and described certain forms of my invention, it is not to be limited to the specific forms or arrangement of parts herein describe and shown. It will be apparent to those skilled in the art that various changes may be made without departing from the scope of the invention and the invention is not to be considered limited to what is shown in the drawings and described in the specification.

What I claim is:

1. A filtration system for converting conventional diesel paper element fuel filter systems to receive a high flow waste oil fiberglass element waste oil filter system comprising:
a mounting plate defined by a circular plate having a first side surface and a second side surface bounded by an outer perimeter sized to fit within a conventional fuel filter housing, said mounting plate having a centrally located coupling pipe having an interior thread formed along said first side surface and an exterior thread formed along said second side surface, said first side surface including a circular groove placed within said outer perimeter for receipt of a sealing gasket, said second side surface having a lower surface and a upper surface with a bevel therebetween, said upper surface including a plurality of apertures fluidly communicating said first side surface and said second side surface.

2. The filter adapted according to claim 1 wherein said fiberglass filtration is further defined as a spin-on PALL canister cartridge having a fiberglass element with a beta value of 200.

3. The fuel management system according to claim 2 wherein said canister cartridge is disposable.

4. A method of converting a conventional diesel engine to operate with waste oil comprising:
removal of a dome top and filter element from a filter body used for filtering of fuel on a conventional diesel engine;
inserting a mounting plate onto said filter body;
securing a fiberglass fuel filter onto said mounting plate;
treating waste oil with a fuel additive and directing said treated waste oil through said fiberglass fuel filter;
injecting the treated and filtered waste oil into a conventional diesel engine for use as fuel.

5. The method according to claim 4 wherein said fuel additive is a composition including naphthalene and methylcyclopentadienyl manganese tricarbonyl together with mixed-t-butylphenols and polyisobutenyl succinimide amide.

6. A filtration system kit for adapting a diesel engine to combust waste oil comprising:
a means of modifying a conventional fuel filtration system to reduce heavy metals and contaminant content in said waste oil;
a additive for stabilizing said waste oil;
wherein said waste oil is filtered and stabilized sufficiently to be injected into a conventional diesel engine for use as a fuel.

7. The filtration system kit according to claim 6 wherein said means of modifying a conventional fuel filtration system includes a mounting plate defined by a circular plate having a first side surface and a second side surface bounded by an outer perimeter sized to fit within a conventional fuel filter housing, said mounting plate having a centrally located coupling pipe having an interior thread formed along said first side surface and an exterior thread formed along said second side surface, said first side surface including a circular groove placed within said outer perimeter for receipt of a sealing gasket, said second side surface having a lower surface and a upper surface with a bevel therebetween, said upper surface including a plurality of apertures fluidly communicating said first side surface and said second side surface; and
a fiberglass element with a beta value of at least about 200.

8. The filtration system kit according to claim 7 wherein said fiberglass element is a cartridge.

9. The filtration system kit according to claim 8 wherein said cartridge is disposable.

10. The filtration system kit according to claim 6 wherein said fuel additive is a composition including naphthalene and methylcyclopentadienyl manganese tricarbonyl together with mixed-t-butylphenols and polyisobutenyl succinimide amide
